(19) United States
(12) Patent Application Publication
(10) Pub. No.: US 2023/0161783 A1
(43) Pub. Date: May 25, 2023

(54) DEVICE FOR ACCELERATING SELF-ATTENTION OPERATION IN NEURAL NETWORKS

(71) Applicant: Seoul National University R&DB Foundation, Seoul (KR)

(72) Inventors: Ye Jin LEE, Seoul (KR); Tae Jun HAM, Sunnyvale, CA (US); Seong Hoon SEO, Seoul (KR); Soo Sung KIM, Seoul (KR); Hyun Ji CHOI, Seoul (KR); Jae W. LEE, Seoul (KR); Sung Jun JUNG, Seoul (KR)

(21) Appl. No.: 17/864,235

(22) Filed: Jul. 13, 2022

(30) Foreign Application Priority Data
Nov. 21, 2021 (KR) 10-2021-0155557
Dec. 28, 2021 (KR) 10-2021-0190300

(51) Int. Cl. G06F 16/2458

(52) U.S. Cl. CPC G06F 16/2468

(57) ABSTRACT

Disclosed is an electronic device including a memory and at least one processor, wherein the at least one processor may calculate a similarity estimate between a first query of a plurality of queries and each of a plurality of keys with respect to a plurality of input entities and select some keys of the plurality of keys as a candidate by comparing the similarity estimate with a threshold, calculate the similarity for the keys included in the candidate in a self-attention operation for the first query, and perform the self-attention operation on the plurality of input entities by repeating a candidate selection process for each of the plurality of queries.

### CROSS-REFERENCE TO RELATED APPLICATION

This present application claims the benefit of priority to Korean Patent Application No. 10-2021-0190300, entitled “DEVICE FOR ACCELERATING SELF-ATTENTION OPERATION IN NEURAL NETWORKS,” filed on Nov. 12, 2021, in the Korean Intellectual Property Office and Korean Patent Application No. 10-2021-0155557, entitled “DEVICE FOR ACCELERATING SELF-ATTENTION OPERATION IN NEURAL NETWORKS,” filed on Nov. 12, 2021, in the Korean Intellectual Property Office, the entire disclosure of which is incorporated herein by reference.

### FIELD

The present disclosure relates to an electronic device for performing a neural network operation, and more particularly, to an algorithm capable of accelerating a self-attention operation in neural networks, and a hardware device on which the algorithm is performed. The present invention resulted from “Developing a model lightweight framework for edge-applied scalable on-device AI computing” of “SW computing industry source technology development” supported by the Ministry of Science and Technology Information and Communication of South Korea (Project No.: 1711134536).

### BACKGROUND

A self-attention operation, which is widely used in natural language processing, computer vision tasks, and the like, is a mechanism mainly used in the field of natural language processing, and may operate by comparing words in a sentence with all the words in a self-sentence and re-adjusting each word to have contextual relevance. The self-attention operation has a disadvantage of requiring a lot of processing time and hardware resources because the operation quantity to be required is large compared to its useful use.

### SUMMARY

An object of the present disclosure is to provide an electronic device that reduces the operation quantity of a matrix inner product operation for calculating an attention score value of a self-attention operation.

Another object of the present disclosure is to provide an electronic device that performs an attention operation only with respect to a key with high similarity to a query by approximating the similarity between the query and the key.

Yet another object of the present disclosure is to provide an electronic device configured as a hardware module having a parallel pipeline structure for performing an algorithm for accelerating a self-attention operation.

An aspect of the present disclosure provides an electronic device including a memory and at least one processor, in which the at least one processor may calculate a similarity estimate between a first query of a plurality of queries and each of a plurality of keys with respect to a plurality of input entities and select some keys of the plurality of keys as a candidate by comparing the similarity estimate with a threshold, calculate the similarity for the keys included in the candidate in a self-attention operation for the first query, and perform the self-attention operation on the plurality of input entities by repeating a candidate selection process for each of the plurality of queries.

Other aspects, features, and advantages than those described above will become apparent from the following drawings, claims, and detailed description of the present disclosure.

According to the embodiments, it is possible to reduce the operation quantity by performing a self-attention operation only on a selective key among input objects using a similarity approximate value between a query and a key.

According to embodiments, by estimating the angle between the query and the key, the attention score is approximated with a much simpler and fewer operation instead of the inner product operation between the query and key, keys with high relevance are selected, and then the self-attention operation is performed only on the corresponding keys. It is possible to minimize the loss of final accuracy of the learning model through an algorithm capable of selecting keys with high relevance.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a flowchart illustrating a self-attention mechanism according to an embodiment.

FIG. 2 is a block diagram illustrating elements constituting a device for accelerating a self-attention operation according to an embodiment.

FIG. 3 is a flowchart illustrating a method for accelerating a self-attention operation according to an embodiment.

FIG. 4 is a flowchart of a method of approximating an attention score according to an embodiment.

FIG. 5 is an example of calculation of a candidate selection process using an attention score approximation according to an embodiment.

FIG. 6 illustrates an example of a method for finding a threshold for each layer according to an embodiment.

FIG. 7 illustrates a block diagram of a pipeline operating according to an algorithm for accelerating a self-attention operation according to an embodiment.

FIG. 8 illustrates a schematic diagram of an acceleration pipeline while executing an algorithm for accelerating a self-attention operation according to an embodiment.

### DETAILED DESCRIPTION

Hereinafter, example embodiments will be described in detail with reference to the accompanying drawings. However, the scope of the present disclosure is not limited or restricted by these embodiments. Like reference numerals illustrated in the respective drawings designate like members.

Terms used in the following description have been selected as general and universal in the related technical field, but there may be other terms depending on the development and/or change of technology, preference of customary technicians, and the like. Therefore, the terms used in the following description should not be understood as limiting the technical idea, but should be understood as exemplary terms for describing the embodiments.

Further, in a specific case, a term which an applicant arbitrarily selects is present and in this case, a meaning of the term will be disclosed in detail in a corresponding description part of the invention. Accordingly, the terms used in the description below should be defined based on not just names of the terms but the meanings of the terms and the contents throughout the present invention.

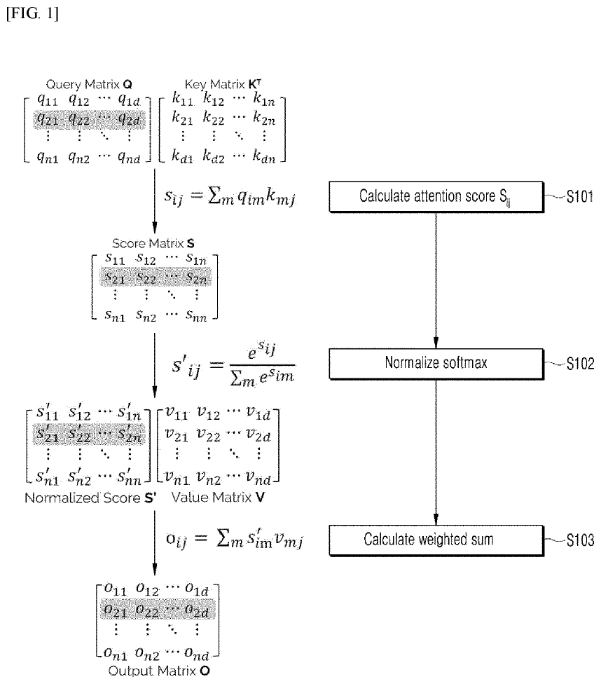

FIG. 1 is a flowchart illustrating a self-attention mechanism according to an embodiment.

An electronic device 100 according to an embodiment may perform a self-attention operation on an input entity according to the following mechanism. The electronic device 100 receives input entities (e.g., words in a sentence), and then converts the input entities into three types of d-dimensional vectors, which are referred to as a query, a key, and a value, respectively. When the number of input entities is N, the collection of queries, keys, and values of the input entities is called a query matrix Q, key matrix K, and value matrix V, respectively, and the sizes all are equal to N*d.

In step S101, the electronic device 100 may calculate an attention score sᵢⱼ indicating the similarity between the ith query in query matrix Q and the ith key in the key matrix K. The electronic device 100 may calculate N*N attention scores through matrix multiplication of a query matrix Q and a key transpose matrix K^{T}, and store the calculated attention scores in an N*N size of attention score matrix S.

In step S102, the electronic device 100 applies softmax normalization to each row of the attention score matrix S to normalize score values to a probability between 0 and 1, and may store the score values in a normalized attention score matrix S′. The softmax normalization means that when there are N scores, an exponential value is obtained for each score and each score is divided by the sum of N exponential values to be normalized. After this normalization, scores with relatively small values converge to 0 or a very small value close to 0, and only some scores with relatively large values have significant probability values. Therefore, pairs with a high attention score value, that is, a high correlation between the query and the key, have significant probability values.

In step S103, when the electronic device 100 obtains a weighted sum of rows of a value matrix V using the normalized attention score matrix S′ as weight, the weighted sum becomes an output matrix O of the self-attention mechanism. This process is performed through matrix multiplication of a normalized attention score matrix N*N and a value matrix N*d. After this process, N queries are further attended on keys that are most similar to (i.e., related to) themselves among N keys.

When calculating the operation quantity of the self-attention mechanism, a multiply-and-accumulate operation N²d in the attention score calculation in step S101, an exponentiation power calculation operation N² in the normalization process for the attention score in step S102, and a multiply-and-accumulate operation N²d in calculating a weighted sum of a value matrix in step S103 are required. Since the operation quantity increases in proportion to the square of the number N of input entities, the operation cost is very high, and actually, in models using the self-attention mechanism, the size of N is limited to a small size for this reason. As a result of analyzing the natural language processing problem due to these limitations, it was confirmed that the length of input sentences is often limited and the time taken for the self-attention mechanism occupies a significant part of model inference time. In the self-attention mechanism, based on the fact that entities unrelated to the input entity have little effect on the final result, in the embodiments of the present disclosure, the final accuracy of the model aims to significantly reduce the operation quantity by eliminating unnecessary operations of the self-attention mechanism within a loss-free range as much as possible. The electronic device 100 according to an embodiment may first calculate an approximation of the attention score using estimation of the angle between the query and the key to execute the attention score calculation operation of step S101 only for relevant keys of the key matrix K.

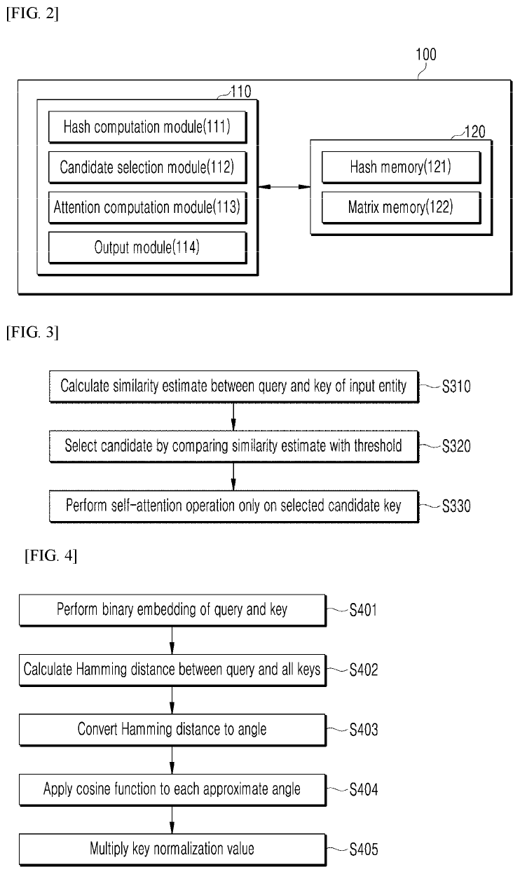

FIG. 2 is a block diagram illustrating elements constituting a device for accelerating a self-attention operation according to an embodiment. The device 100 for accelerating the self-attention operation (hereinafter, referred to as “device” or “electronic device”) may include a processor 110 and a memory 120. The processor 110 may include a hash computation module 111, a candidate selection module 112, an attention computation module 113, and an output module 114. The memory 120 may include a hash memory 121 and a matrix memory 122. However, the present invention is not limited thereto, and other general-purpose components other than the components illustrated in FIG. 1 may be further included in the electronic device 100. The electronic device 100 may approximate the attention score by using a bitwise xor, a lookup table reference, and a multiplication operation. In one embodiment, the attention score approximation may be performed by the following hardware module.

The electronic device 100 may approximate the attention score by dividing a preprocessing step and an execution step. In the preprocessing step, the hash computation module 111 may obtain a hash value of the given key matrix K and store the obtained hash value in the key hash memory 121. In addition, norm computation module calculates the length of each of N keys in the key matrix K. The execution step may be divided into the following four sub-steps.

1) The hash computation module 111 may obtain a hash value of the query matrix Q and store the obtained hash value in a query hash buffer.

2) The candidate selection module 112 may calculate an approximate attention score and then compare the calculated approximate attention score with a pre-learned threshold t. According to the comparison result, the self-attention operation may be performed later only on a selected key (candidate).

3) The attention calculation module 113 may calculate an accurate attention score only for the selected candidate keys (step S110 of FIG. 1). The attention calculation module 113 may calculate a score and then calculate a value e^{x} for softmax normalization.

4) The output module 114 may normalize the previously obtained values in order to complete the softmax normalization, and then store the normalized values in the output memory 122.

The electronic device 100 may apply query-level pipelining and more subdivided pipelining in each pipeline step. An operation optimizing process through a custom float type and a lookup table may be included.

FIG. 3 illustrates a flowchart of a method for accelerating a self-attention operation according to an embodiment. The electronic device 100 may perform the self-attention mechanism using an attention-score approximation algorithm that may approximate the attention-score value described in step S101 of FIG. 1 with much simpler and fewer operations.

In step S310, the electronic device 100 may calculate a similarity estimate (approximate value) between the query and the key of the input entity. A similarity approximation may be derived as follows. With respect to N input entities, when converted into a d-dimensional query, key, and value vector, for example, an attention score sᵢⱼ for a d-dimensional i-th query qᵢ and a d-dimensional j-th key kⱼ may be obtained from an inner product value of two vectors as shown in Equation 1 below.

sᵢⱼ=qᵢ·kⱼ=∥qᵢ∥∥kⱼ∥ cos θ [Equation 1]

θ represents an angle between qᵢ and kⱼ. When a query qᵢ is given, a relationship of sᵢⱼ∝∥kⱼ∥ cos θ is established because a value ∥qᵢ∥ is fixed for N keys.

In one embodiment, the electronic device 100 may first approximate a value of cos θ through sign random projection (SRP). First, k unit vectors v₁, v₂ . . . vₖ may be randomly determined in a d-dimensional vector space, and a hash function for a vector x may be defined as in Equation 2 below.

h(x)=(hᵥ₁(x),hᵥ₂(x) . . . hᵥₖ(x)),where hᵥ(x)=sing(v·x) [Equation 2]

After hash values h(x), h(y) of two vectors x and y are obtained, an angle θ_{x,y} between the two vectors may be approximated as in Equation 3 below.

$${θ}_{x , y} \approx \frac{π}{k} \cdot hamming ( h ( x ) , h ( y ) ) \qquad [ Equation 3 ]$$

In Equation 3, an orthogonal vector k (e.g., an orthogonal vector generated by a Gram-Schmidt process) may be applied. By using the orthogonal vector, it is possible to prevent unnecessary emphasis on a specific direction by allowing two or more random vectors to point a similar direction. An angle (estimator) estimated according to a Hamming distance is not biased but still contains errors. When the errors are not corrected, an angle estimated with approximately half probability may be applied larger than an actual angle. If the angle is overestimated (i.e., the similarity between the two vectors is underestimated), keys that are relevant to the query may be missed, the angle may be corrected from the estimated angle by a biased angle θ_{bias}. When summarized by considering the bias and correction, the attention score may be approximated as in Equation 4 below.

sᵢⱼ∝∥kⱼ∥ cos θ=∥kⱼ∥ cos(π/k·hamming(h(x),h(y))−θ_{bias}) [Equation 4]

When the attention score value is approximated as in Equation 4, the operation in which d multiply-and-accumulates have been originally required is changed to a combination of a simple bitwise xor, a lookup table reference (cosine value), and a multiplication.

In step S320, the electronic device 100 may select a candidate by comparing a similarity estimate, that is, an approximation of the attention score, with a threshold. The threshold is a value that is pre-trained and designated, and it may be considered to have a significant score value only when the attention score approximation is greater than the threshold t. When the attention score approximation is less than the threshold t, subsequent operations are not performed at all so that the operation quantity is significantly reduced. Step S310 will be described in detail with reference to FIG. 4 to be described below.

In step S330, the electronic device 100 may perform a self-attention operation only on the selected candidate key. With respect to a specific query, based on the similarity approximation, the electronic device 100 may first determine whether the key is a significant value affecting the self-attention operation result, and then calculate the accurate attention score with the query with respect to the key value corresponding to the significant value to reduce the operation quantity of the entire self-attention operation.

FIG. 4 illustrates a flowchart of a method of approximating an attention score according to an embodiment. The electronic device 100 may approximate an attention score by estimating the angle of a key value with respect to a specific query. The attention score may be operated by the inner product of the query matrix and the key matrix, but the electronic device 100 according to an embodiment may calculate an approximation of the attention score using only a simpler operation than matrix multiplication.

In step S401, the electronic device 100 may perform generating binary embedding of the query and the key. The electronic device 100 may concisely express a key and a query of an input entity by using a k-bit hash called binary embedding. In embodiments, the electronic device 100 may hash the input entity to a k-bit value using sign random projection (SRP). The SRP is a method of mapping each input vector to a binary hash vector, and at this time, the angular distance between two input vectors is mapped to be similar to the angular distance between two binary hash vectors. A random d-dimensional vector v may initialize each component with values sampled from a normal distribution N(0,1). With respect to the input vector x, if v·x≥0, a value of 1 is allocated as a hash bit value, and if not, a value of 0 is allocated as a hash bit value. With respect to the input vector x, a k-bit binary hash function h(x) may be executed by repeating k random vectors v₁, . . . vₖ k times. The hash function is the same as in Equation 2 described above. In the hash function, sing(x) has a value of 1 if x≥0, and has a value of 0 if not.

The electronic device 100 multiplies a k×d orthogonal matrix (i.e., a matrix in which row vectors are unit vectors orthogonal to each other) by x to obtain a k-bit hash value for the d-dimensional vector x, and then may allocate a hash bit of 1 if positive and 0 if not to each element. Here, ndk multiplications (n(d−1)k additions) are required to calculate hash values for n vectors, and the electronic device 100 performs hash calculations on all queries and all keys of the input entity so that the total number of multiplications required in the hash operation may be 2ndk. This cost is negligible compared to 2n²d, which is the cost of calculating the attention score inner product operation and the value matrix when n is a number much larger than k. However, considering a neural network model in which at least n is limited (e.g., n is 128 in a small model), it is necessary to minimize the hash calculation. In an embodiment, the electronic device 100 may utilize a kronecker product that efficiently calculates a matrix multiplication by using an orthogonal matrix in order to minimize the calculation quantity for hash calculation. The kronecker multiplication is a matrix that specifically expresses the tensor product of two matrices. The electronic device 100 may efficiently calculate a hash value using an orthogonal matrix.

While calculating the hash value of each key, the electronic device 100 may also calculate and store the standard of the key.

In step S402, the electronic device 100 may calculate a Hamming distance between the query hash value Zₓ and all key's hash value K_{y}∈{K₁, . . . Kₙ}, respectively. First, the electronic device 100 may calculate a query hash value h(Qₓ). The electronic device 100 may calculate a Hamming distance between the query hash and all keys.

In step S403, the electronic device 100 may convert the Hamming distance into an angle. That is, the angle between the vectors x and y may be estimated. With respect to many random hyperplanes, each intuitively defined as one of k random vectors v₁, . . . vₖ, if two vectors are in the same plane, the two vectors are more likely to have a smaller angle. For example, if x1 and x2 are on the same plane in any 3 of 4 hyperplanes, both the Hamming distance and the angular distance are small.

The electronic device 100 converts the Hamming distance into an angle θ_{Q}_{ₓ}, K_{y} for all 1≤y≤n using Equation 3, and a bias θ_{bias} is applied.

In step S404, the electronic device 100 may apply a cosine function to each approximate angle, and in step S405, the electronic device 100 may multiply the key normalized value. The resulting value represents an inner product estimate between the normalized query and the key representing the similarity of the two vectors. Equation 5 below describes the relationship.

$$Sim ( {Q}_{x} / ‖ {Q}_{x} ‖ , {K}_{y} ) = ( {Q}_{x} / ‖ {Q}_{x} ‖ ) \cdot {K}_{y} = ‖ {K}_{y} ‖ cos ( {θ}_{{Q}_{x} , {K}_{y}} ) \approx ‖ {K}_{y} ‖ cos ( max ( 0 , \frac{π}{k} \cdot hamming ( h ( {Q}_{x} ) , h ( {K}_{y} ) ) - {θ}_{bias} ) ) \qquad [ Equation 5 ]$$

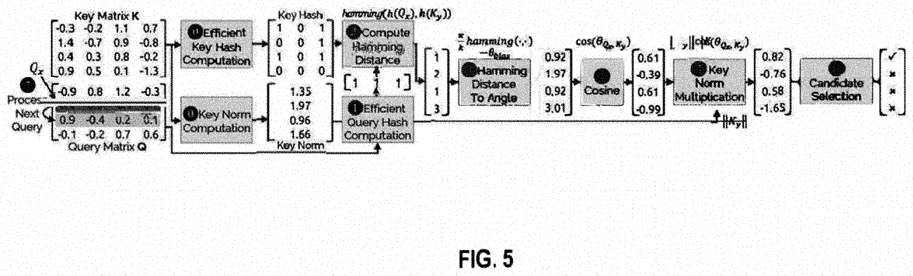

FIG. 5 is an example of calculation of a candidate selection process using an attention score approximation according to an embodiment. The electronic device 100 may perform the following process for the query Qₓ with respect to the query matrix Q and the key matrix K.

First, in step 0, hash calculation and normalization calculation may be performed with respect to the K matrix.

In step 1, the Q matrix may be hash-calculated, and in step 2, the Hamming distance for all keys in K matrices may be calculated.

In step 3, the Hamming distance may be converted to an angle, and the bias may be removed.

In step 4, a cosine function value for the two angles may be calculated.

In step 5, the cosine value is multiplied by the key normalized value, and in step 6, the value is compared with a threshold to select a candidate among all key values for the query Qₓ. The electronic device 100 may repeat steps 0 to 6 for the next query Qₓ₊₁.

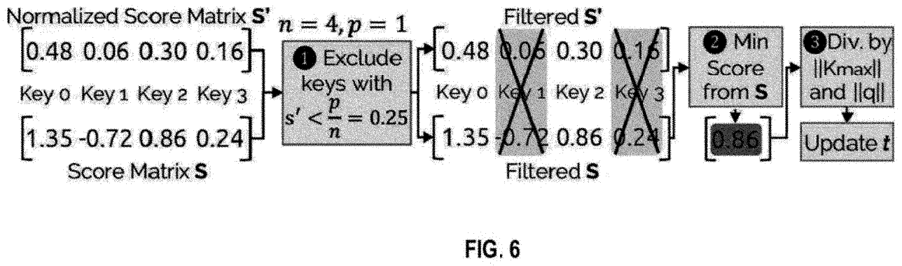

FIG. 6 illustrates an example of a method for finding a threshold for each layer according to an embodiment. In embodiments, there are many methods of filtering irrelevant keys for the specific query based on a similarity estimate. For example, attention score values are sorted and a specific number of highest score values may be selected. However, since the sorting algorithm has n log n and time complexity, it is difficult to be implemented efficiently in hardware, especially when n is large.

In an embodiment, the electronic device 100 may filter potentially irrelevant keys by comparing the approximate attention score value with a predefined threshold t. Since each sub-layer of a neural network may have a different attention score distribution, a different threshold reference may be required for each layer and each attention head. However, a model such as BERT-large has 384 lower layers and 16 self-attention heads that use the self-attention mechanism, and it is practically impossible to set user-defined hyperparameters for thresholds for each layer and each self-attention head. In one embodiment, the electronic device 100 may automatically designate a threshold for each lower layer corresponding to the degree of approximation of a single hyperparameter designated by the user.

In one embodiment, in order to find a threshold for each layer, the neural network model inference may be executed and characteristics of each layer utilizing the self-attention may be examined.

The electronic device 100 may examine the softmax normalized attention score for each query for each call of the self-attention operation for a specific layer. In step 1 with reference to FIG. 6, the electronic device 100 identifies a key set having a softmax normalized attention score greater than

$$p \cdot \frac{1}{n}$$

with respect to n input entities and a user-specified hyperparameter p. The hyperparameter p represents the approximate degree. For example, if the user specifies the hyperparameter to 2 with respect to 200 input entities, it is meant that it is considered that a key with a softmax normalized score greater than 0.01 is relevant to the query. A larger hyperparameter p denotes an aggressive approximation, and a smaller hyperparameter p denotes a conservative approximation.

In step 2 with reference to FIG. 6, the electronic device 100 pays attention to a key having a minimum softmax normalized attention score value in an identified key set.

In step 3, the electronic device 100 normalizes the attention score by dividing a query normalization ∥q∥ key maximum key normalization value ∥Kₘₐₓ∥=max(∥K₁∥, . . . , ∥Kₙ∥). The resulting value becomes the threshold t. The process is repeated for several input data in a training set to find the average of the thresholds for each layer. While the inference is executed, a value obtained by multiplying the threshold t by the maximum key normalized value t·∥Kₘₐₓ∥ is compared with the similarity estimate to determine whether each key in the key matrix is relevant to a current query. Equation 6 below may specify a condition for determining whether the calculation of a key K_{y} may be skipped with respect to a query Qₓ.

$$t \cdot ‖ {K}_{max} ‖ \geq ‖ {K}_{y} ‖ \cdot cos ( max ( 0 , \frac{π}{k} \cdot hamming ( h ( {Q}_{x} ) , h ( {K}_{y} ) ) - {θ}_{bias} ) ) \qquad [ Equation 6 ]$$

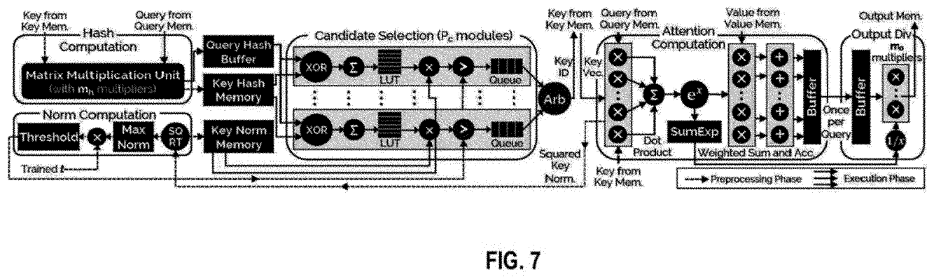

FIG. 7 illustrates a block diagram of a pipeline operating according to an algorithm for accelerating a self-attention operation according to an embodiment. FIG. 7 intuitively illustrates a flowchart of high-level data. A preprocessing phase and an execution phase are indicated by dotted and solid lines, respectively. In the pipeline block diagram, the electronic device 100 receives a key matrix, a query matrix, and a value matrix to generate an output matrix.

With respect to the input data, the preprocessing phase starts immediately. In the preprocessing phase, the hash computation module 111 calculates a k-bit hash value of each row of the key matrix, and stores the calculated hash value in the key hash memory 121. Similarly, the normalization of each key vector is calculated using a norm computation module and stored in the key normalization memory 121. After the preprocessing phase ends, the execution phase starts, in which each row of the query matrix is sequentially processed to output a single row of the output matrix once. Particularly, with respect to each query, a P_{c} candidate selection module 112 retrieves the hash and normalized values of a key P_{c} at each cycle, and outputs the maximum P_{c} selected candidate key ID (i.e., row ID) to an output queue of each module. Then, the selected key ID is transmitted to the attention computation module 113. The attention computation module 113 calculates and accumulates the contribution of the selected key to the output (for the current query) of every cycle. When all the keys selected for the specific query have been calculated, the output module (Output Div) 114 performs a division operation on this output. This process is repeated for each row (i.e., each query) of the query matrix, and the whole process ends when the last query is processed.

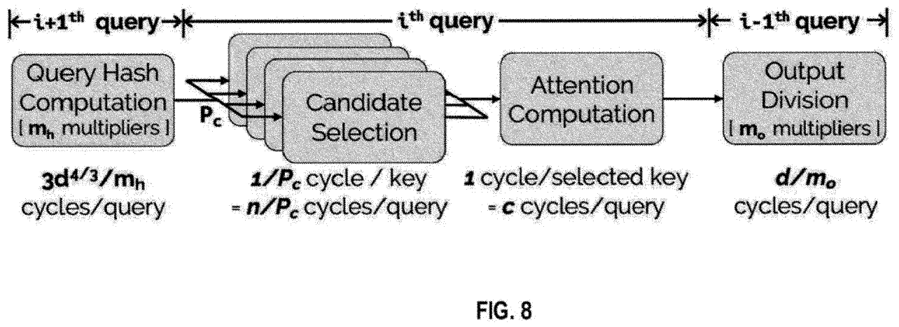

FIG. 8 illustrates a schematic diagram of an acceleration pipeline while executing an algorithm for accelerating a self-attention operation according to an embodiment. The process of sequentially processing Qₓ and Qₓ₊₁ in FIG. 7 may operate a hardware module execution by applying the pipeline concept. With respect to the given n and d, it takes cycle time 3d^{4/3}(n [symbol] )/mₕ for preprocessing this pipeline. In the execution phase, each of the four hardware modules may cause a bottleneck phenomenon in the pipeline. When C is the number of candidates selected by the candidate selection module 112, the time required to process a single query may be maximum 3d^{4/3}/mₕ, n/P_{c}, c, d/mₒ. To prevent the bottleneck phenomenon and maximize a throughput, P_{c}, mₕ, mₒ is appropriately selected to adjust properly the balance of the pipeline. In particular, it is ideal that the modules other than the attention computation module 113 (which takes a cycle c) configure parameters so as not to cause the bottleneck phenomenon in the pipeline. For example, in the case of designing a pipeline that may achieve up to 8 speed improvements (i.e., it takes n/8 or more cycles to process the query) using the approximation, 3d^{4/3}/mₕ, n/P_{c}, and d/mₒ need to be less than or equal to n/8, respectively. When is 64, a configuration such as P_{c}=8, mₕ=64, mₒ=8 may satisfy the above requirements when n is greater than or equal to 96, and the speed improvement to be achieved in this configuration may be min(n/c,8). That is, the speed improvement is often determined by the efficiency of an approximation method that reduces the number of keys (i.e., c) to be processed with respect to the attention computation module 113.

In addition, since each row of the key/value matrix may be independently processed, in one embodiment, the electronic device 100 may extend a pipeline capable of using the attention computation module 113 in parallel.

The embodiments described above may be implemented in hardware components, software components, and/or a combination of hardware components and software components. For example, the device, the method, and the components described in the embodiments may be implemented using, for example, one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or other devices capable of executing and responding instructions. The processing device may perform an operating system OS and one or more software applications performed on the operating system. In addition, the processing device may also access, store, manipulate, process, and generate data in response to execution of software. For convenience of understanding, although one processing device is sometimes described as being used, those skilled in the art will appreciate that the processing device includes a plurality of processing elements and/or a plurality of types of processing elements. For example, the processing device may include a plurality of processors or one processor or one controller. In addition, other processing configurations, such as a parallel processor are also possible.

Software may include computer programs, codes, instructions, or one or more combinations thereof, and may configure a processing device to operate as desired, or to instruct independently or collectively the processing device. Software and/or data are interpreted by the processing device or may be permanently or temporarily embodied in any type of machine, a component, a physical device, virtual equipment, a computer storage medium or device, or a signal wave to be transmitted to provide instructions or data to the processing device. The software may be distributed on a computer system connected via a network, and may be stored or executed in a distributed method. The software and data may be stored in one or more computer readable recording media.

The method according to the embodiment may be implemented in a form of program instructions which may be performed through various computer means to be recorded in a computer readable medium. The computer readable medium may include a program instruction, a data file, and a data structure alone or in combination. The program instructions recorded in the medium may be specially designed and configured for the exemplary embodiments or may be publicly known to and used by those skilled in the computer software art. Examples of the computer readable medium include magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program instruction. Examples of the program instructions include advanced language codes executable by a computer by using an interpreter and the like, as well as machine language codes generated by a compiler. The hardware devices may be configured to operate as one or more software modules in order to perform the operations of the embodiments, and vice versa.

As described above, although the example embodiments have been described by the restricted example embodiments and the drawings, various modifications and variations can be made from the above description by those skilled in the art. For example, even if the described techniques are performed in a different order from the described method, and/or components such as a system, a structure, a device, a circuit, etc. described are coupled or combined in a different form from the described method, or replaced or substituted by other components or equivalents, an appropriate result can be achieved. Therefore, other implementations, other example embodiments, and equivalents to the appended claims fall within the scope of the claims to be described below.

What is claimed is:

1. An electronic device comprising:
a memory; and
at least one processor, wherein the at least one processor
calculates a similarity estimate between a first query of a plurality of queries and each of a plurality of keys with respect to a plurality of input entities and selects some keys of the plurality of keys as a candidate by comparing the similarity estimate with a threshold,
calculates the similarity for the keys included in the candidate in a self-attention operation for the first query, and
performs the self-attention operation on the plurality of input entities by repeating a candidate selection process for each of the plurality of queries.

2. The electronic device of claim 1, wherein the at least one processor calculates the similarity estimate by estimating an angle between a key vector and a query vector of the input entity.

3. The electronic device of claim 1, wherein the at least one processor calculates the similarity estimate for the query and the key by including a Hamming distance calculation, a multiplication operation, a subtraction operation, and a cosine function.

4. The electronic device of claim 1, wherein the at least one processor calculates an attention score according to the query matrix and an inner product operation with respect to the key selected as the candidate.

5. The electronic device of claim 1, wherein the at least one processor selects one or more thresholds for each layer based on the degree of approximation of a first hyperparameter.

6. The electronic device of claim 1, wherein the at least one processor includes a hash computation module, a candidate selection module, an attention computation module, and an output module, and the memory configures a hardware module to include a hash memory and a matrix memory.

7. The electronic device of claim 1, wherein the at least one processor is configured to process each operation of the plurality of input entities in a plurality of pipeline structures.

8. A method for accelerating a self-attention operation comprising:
a first step of calculating a similarity estimate between a first query of a plurality of queries and each of a plurality of keys with respect to a plurality of input entities;
a second step of selecting some keys of the plurality of keys as a candidate by comparing the similarity estimate with a threshold;
a third step of calculating the similarity for the keys included in the candidate in a self-attention operation for the first query; and
a fourth step of performing the self-attention operation on the plurality of input entities by repeating the first step to third step for each of the plurality of queries.

9. The method for accelerating the self-attention operation of claim 8, wherein the first step is to calculate the similarity estimate by estimating an angle between a key vector and a query vector of the input entity.

10. The method for accelerating the self-attention operation of claim 8, wherein in the first step, the similarity estimate for the query and the key is calculated by including a Hamming distance calculation, a multiplication operation, a subtraction operation, and a cosine function.

11. The method for accelerating the self-attention operation of claim 8, wherein the fourth step is to calculate an attention score according to the query matrix and an inner product operation with respect to the key selected as the candidate.

12. The method for accelerating the self-attention operation of claim 8, wherein the second step is to select one or more thresholds for each layer based on the degree of approximation of a first hyperparameter.

13. The method for accelerating the self-attention operation of claim 8, wherein at least one processor of an electronic device operating the first to fourth steps includes a hash computation module, a candidate selection module, an attention computation module, and an output module, and a memory of the electronic device configures a hardware module to include a hash memory and a matrix memory.

14. The method for accelerating the self-attention operation of claim 8, wherein the first to fourth steps are to process each operation of the plurality of input entities in a plurality of pipeline structures.

15. A computer readable non-transitory recording medium that stores a computer program including at least one instruction for executing the method for accelerating the self-attention operation according to any one of claims 8 to 14 by an electronic device.
